(19) United States
(12) Patent Application Publication
(10) Pub. No.: US 2025/0139465 A1
(43) Pub. Date: May 1, 2025

(54) MACHINE LEARNING-BASED PREDICTIVE MODELING FRAMEWORK FOR IDENTIFYING AND SCORING CRITICAL SIGNALIZED INTERSECTIONS

(71) Applicant: ITERIS, INC., SANTA ANA, CA (US)

(72) Inventors: MASOUD HAMEDI, POTOMAC, MD (US); ALICAN KARAER, TALLAHASSEE, FL (US)

(21) Appl. No.: 18/926,101

(22) Filed: Oct. 24, 2024

Related U.S. Application Data
(60) Provisional application No. 63/545,680, filed on Oct. 25, 2023.

(51) Int. Cl. G06N 5/022

(52) U.S. Cl. CPC G06N 5/022

(57) ABSTRACT

A machine learning-based modeling framework provides an approach for quickly identifying and prioritizing intersection safety improvements, and for analyzing adverse traffic events such as collisions and crashes at signalized intersections within a transportation network, to generate risk scores for intersection safety performance screening in a large such network. The framework enables machine learning models to be run using current data to identify dangerous locations and treat them with traffic safety measures, without having available up-to-date or recent crash data. These machine learning models also account for dangerous behavior by considering speed and excessive hard braking and hard acceleration to produce more accurate risk scores.

### CROSS-REFERENCE TO RELATED PATENT APPLICATION(S)

This patent application claims priority to U.S. provisional patent application 63/545,680, filed on Oct. 25, 2023, the contents of which are incorporated in its entirety herein. In accordance with 37 C.F.R. § 1.76, a claim of priority is included in an Application Data Sheet filed concurrently herewith.

### FIELD OF THE INVENTION

The present invention relates generally to the field of traffic management. More specifically, the present invention relates to systems and methods of analyzing connected vehicle event data, speed data, and other information having relevance to vehicle collisions and crashes using machine learning models to identify critical signalized intersections, and provide predictions and forecasts of traffic safety for risk scoring, where historical crash data is limited or does not exist.

### BACKGROUND OF THE INVENTION

Signalized intersections are usually considered crash hotspots within a transportation network, at least because of their multiple conflicting approaches, large differences in traffic speed, and generally being high-traffic thoroughfares. Historical crash data is traditionally used for safety studies of signalized intersections, but is it often the case that historical crash data is either limited, old, or simply unavailable.

Historical data of crash records may be incomplete or unavailable for several reasons. Official crash records are collected, verified, and published by agencies. But an agency may never collect crash data for a particular location at all, or may not have been retained over time. Every jurisdiction that does collect and maintain such data does so differently, and data that is gathered and stored often has a time lag of several months or even years, depending on processes for such collection and retention.

The traditional industry practice for locating and analyzing safety hotspots is to analyze historical crash data to identify areas that experience the highest number of crashes. There are several problems with such an approach. It is always reactive, and necessarily includes a time lag; crashes happen, concerns are raised, attempts are made to address those concerns, and then traffic planners have to wait to see how crash statistics change over time to see the impact. And further, crash data only contains crashes that both occurred and get reported; it is sometimes the case that minor crashes are not reported, and in addition there are near misses that are also relevant to traffic safety analysis. Neither of these are reflected in crash data.

Accordingly, there is a need in the existing art for improvements in traffic-related data science that are able to model different types of data to produce more accurate predictions of collisions and crashes at signalized intersections for transportation management. There is a further need in the existing art for improvements in modeling of relevant traffic data for predicting collisions and crashes at signalized intersections where historical crash data is limited or unavailable. There is still a further need in the existing art for modeling of traffic-related data that includes one or more implementations of machine learning-based models that extract and assign weights to variables that are most relevant to potential traffic collisions and crashes, and produce reliable, actionable, and timely predictions where historical crash data is limited or unavailable.

### BRIEF SUMMARY OF THE INVENTION

In the world of traffic data science, emerging connected vehicle technology provides a wealth of vehicular motion information and other characteristics of vehicle operation in event data. This event data allows for proactive safety evaluations even where historical crash data is of limited use or not available. For instance, crowd-sourced GPS probe datasets traditionally providing average segment speeds now include event-based data such as hard acceleration and hard braking, with precise location and time information as well as speed and heading status, collected from onboard sensors. The present invention provides a framework for processing connected vehicle event data, and analyzing speeding and other operational behavior from such event data as well as other data that is relevant to vehicle operation and behavior, in which machine learning-based predictive models are developed for identifying critical signalized intersections in the absence of useful historical crash data.

These machine learning-based predictive models are trained on historical crash data to find relationships between certain data elements and actual, historical crashes. The outputs of these models provide a prediction of safety risk. If these models are trained for locations where crash data is available, the model may then be applied elsewhere, using connected vehicle event data, other speed data, geometric data, traffic level volume data (and other relevant information) instead of crash data (where such crash data is not available for various reasons or is lagging). Future iterations of such models may then be trained on connected vehicle event data, other speed data, and further data that is validated by data for crashes that happen on a forward basis, so that safety risk can be analyzed proactively without waiting for more crashes to occur, and therefore continuously monitored.

More specifically, the machine learning-based predictive models developed within this framework combine information such as hard breaking, hard acceleration, traffic volume, speeding characteristics, and intersection geometry at particular intersections. The models generate estimates of the number of crashes at such intersections, and these results are validated using, where available, historical crash data. The framework comprising these models may therefore be applied to estimate the number of crashes that occur in intersections, and may be applied to rank intersections for collision or danger risk and generate detailed visualizations showing hard braking, hard acceleration and speeding patterns for each intersection approach.

The present invention is a modeling framework that develops and applies these machine learning-based predictive models. The modeling framework enables a proactive approach to intersection safety, instead of a reactive approach in which agencies currently need to wait for crashes to occur and historical data to accumulate prior to analyzing and identifying dangerous locations. The traditional crash-based approach therefore relies on actual crashes that happened and reported. However, such data does not include near-misses and dangerous behavior that could have resulted in a crash. In the modeling framework of the present invention, once models are trained and validated, they can be run using current data to identify dangerous locations and treat them with traffic safety measures. The modeling framework also accounts for dangerous behavior by considering high speeds as well as excessive hard braking and hard acceleration, thereby producing more accurate safety risk scores.

It is therefore one objective of the present invention to provide systems and methods of assessing motorist behavior within a transportation network as it pertains to adverse traffic incidents and events. It is another objective of the present invention to provide systems of methods of assessing motorist behavior as it pertains to adverse traffic incidents and events using varied data sources without reliance upon historical crash data at specific locations within a transportation network, such as at signalized intersections. It is another objective of the present invention to provide systems and methods of identifying critical signalized intersections, and still further to provide predictions and forecasts of traffic safety where historical crash data is limited or does not exist. It is still another objective of the present invention to provide systems and methods of assessing motorist behavior within a transportation network as it pertains to adverse traffic incidents and events using machine learning-based predictive models, in applications of artificial intelligence that analyze and predict particular behavior where no historical event data is present.

It is yet a further objective of the present invention to provide systems and methods of assessing motorist behavior at locations such as signalized intersections as it pertains to adverse traffic incidents and events that is entirely independent of infrastructure, and using data that is widely representative of a much larger region, such as a state or nation. It is yet a further objective of the present invention to provide a framework for assessing motorist behavior as it pertains to adverse traffic incidents and events that enables larger, region-wide safety insights and ranking for all intersections within a region, enables agencies to be proactive with implementing safety countermeasures, and enables prioritization of safety projects. It is yet a further objective to provide a framework for analyzing change of behavior and conduct in before-and-after studies within transportation networks.

Other objectives, embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a systemic diagram illustrating elements of a framework according to the present invention;

FIG. 2 is a flowchart of steps in a process of performing the framework according to one embodiment of the present invention;

FIG. 3 is a block diagram illustrating an application of datasets for machine learning models, according to one embodiment of the present invention; and

FIG. 4 is a graphical illustration of an application of extreme gradient boosting.

### DETAILED DESCRIPTION OF THE INVENTION

In the following description of the present invention, reference is made to the exemplary embodiments illustrating the principles of the present invention and how it is practiced. Other embodiments will be utilized to practice the present invention and structural and functional changes will be made thereto without departing from the scope of the present invention.

The present invention provides a modeling framework for analyzing adverse traffic incidents and incident-related characteristics to identify critical signalized intersections (and other critical points) within a transportation network. The modeling framework may be used to generate predictions of the number of crashes that occur in particular intersections, and may be applied to rank intersections for risk to realize substantial improvements in intersection safety. The modeling framework of the present invention includes a machine learning-based modeling engine within which one or more machine learning models are developed that analyze connected vehicle event data, and other data representing related speed behavior, to predictions adverse traffic events where historical crash data is limited or does not exist.

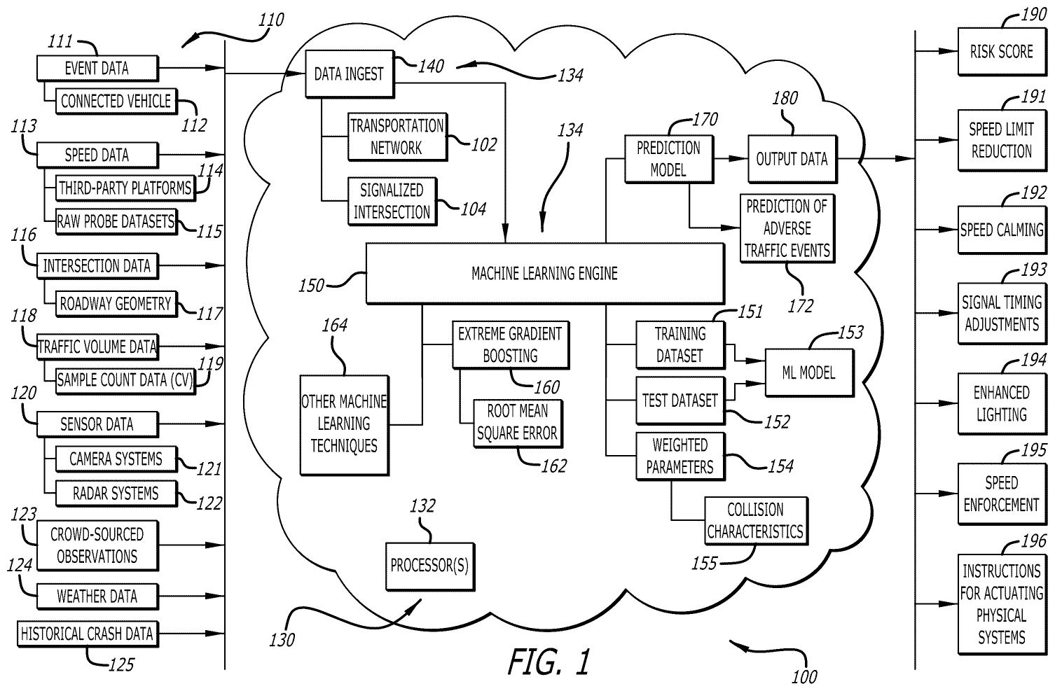

FIG. 1 is a systemic diagram illustrating various aspects of a modeling framework 100 according to the present invention. The modeling framework 100, and associated processes, are embodied within one or more systems and/or methods that are performed in a plurality of data processing modules 134 and which are components within a computing environment 130. These data processing modules 134 may be configured to run within external cloud computing environments (and accessed therefrom by the framework), and also may be configured to run locally on devices hosting the framework, such as on mobile computing devices, “smart” phones, earphones or earbuds, on other wearable, internet-enabled devices such watches and eyeglasses, and in automotive platforms. Still further, one or more of the data processing modules 134 may be configured to run within, and executed on, edge computing environments and be responsive to natural language instructions, either verbal, written, or gesture-based. One or more processors 132 may be configured to execute program instructions or routines to perform the elements, modules, components, and functions described herein that together comprise and are embodied within the plurality of data processing modules. The words “module” and “modules” as used herein, may refer to (and the data processing modules may themselves comprise, at least in part) logic embodied in hardware or firmware, or to a collection of software instructions, written in a programming language, such as, for example, Java, Python, C, or assembly. One or more software instructions for such modules may be embedded in firmware. It will be appreciated that the functional data processing modules may include connected logic modules, such as gates and flip-flops, and may include programmable modules, such as programmable gate arrays or processors. The data processing modules described herein may be implemented as either software and/or hardware modules and may be stored in a storage device. It is to be additionally understood that the data processing modules, and the respective components of the present invention that together comprise the specifically-configured elements, may interchangeably be referred to as “components,” “modules,” “algorithms” (where appropriate), “engines,” “networks,” and any other similar term that is intended to indicate an element for carrying out a specific data processing function.

The plurality of data processing modules 134 define distinct activities and functions for processing input data 110 that at least includes event data 111, such as vehicular event data collected from connected vehicles 112 and using connected vehicle platforms, and other information, such as speed data 113 and intersection-related data 116. The modeling framework 100 predicts adverse traffic events 172 and incidents such as collisions and crashes at a signalized intersection 104, and under specific conditions, by performing various mathematical calculations and executing various algorithms within the machine learning-based predictive models, and further generates outputs such as a risk score 190 for a signalized intersection 104 within a transportation network 102.

The modeling framework 100 ingests, receives, requests, or otherwise obtains input data 110 of different types, and from different sources. The data processing modules 134 may include a data ingest module 140 governing intake of the input data 110; for example, this may occur via one or more application programming interfaces (APIs) or via other interfaces designed to capture and provide input data 110 for the modeling framework 100. Regardless, the input data 110 for the modeling framework 100 includes, as noted above, event data 111 from connected vehicles 112, as well as speed data 113 and intersection-related data 116, and may further include additional information that is relevant to predicting the occurrence of traffic collisions and crashes where historical crash data 125 is limited or unavailable.

Event data 111 includes information such as acceleration change events, for example hard acceleration information and hard braking information that reflect motorist behavior where adverse events have occurred or about to occur. Event data 111 may also include ignition status events, such as trip started and trip ended, and seatbelt status, such as clicked and unclicked. Each of these categories of information may further include a time stamp, a location, a speed, and heading information.

Event data 111 may be provided from different sources, such as from connected vehicle 112 platforms (for example, those provided by Arity, AWS, Microsoft, IBM, and others). Such event data 111 may also be provided directly by systems configured onboard connected vehicles 112 themselves through original equipment manufacturers (OEMs). Regardless, event data 111 may be considered as a proxy for risky driving behavior that is separate from speed information.

Speed data 113 represents vehicle speed characteristics for all approaches to a signalized intersection 104. Speed data 113 may be provided by a third-party transportation analytics software platform 114 and associated speed-centric modules, such as those provided by ClearGuide™, which produces such data by, for example, processing high-resolution vehicle trajectories. Speed data 113 may also be contained in raw probe datasets 115, such as that supplied by vehicle GPS trajectory data aggregators such as HERE, Arity, TomTom, Waze, INRX, etc.

In an example of how relevant speed data 113 is ingested from a source such as ClearGuide™, the modeling framework 100 may download geospatial vector data such as in an export of data in Shapefile (SHP) format, where link-based data includes information such as a speed limit or limits for that link. It also includes all percentiles of speed as well as the number of samples in each percentile category by hour of the day (for example, in 5-mile per hour increments). The modeling framework 100 may also download a CSV export file containing data that represents a percentage of vehicles speeding over the speed limit for each link or Traffic Message Chanel (TMC). Additionally, the modeling framework 100 may download a CSV export file containing standard deviation of speeds, which is again link and TMC-based.

The modeling framework 100 may then filter the SHP export and delete any controlled access links. The modeling framework 100 may then clip links to each intersection zone. To determine speeding at each signalized intersection 104, the modeling framework 100 pulls speeding information from the CSV export to each link by matching the TMC code and calculates maximum values of speeding percentile and standard deviation of the speed for each signalized intersection 104 among the crossing links.

Intersection data 116 includes intersection characteristics, such as roadway geometry 117, that represent intersection complexity. Roadway geometry 117 is a combination of physical infrastructure attributes, including number of approaches, turn lanes, angles between approaches, and the number of links crossing the signalized intersection 104. Such intersection data 116 may also include information such as traffic volume levels at a signalized intersection 104. This information may be produced by counting unique vehicles within probe streams associated with particular intersection locations.

Input data 110 may also separately include traffic volume data 118. This type of information, in addition to that provided by probe-based counts as noted above, may include sample count data 119 from connected vehicles 112. Traffic volume data 118 may also include average annual daily traffic (AADT). This AADT data may be obtained from organizations or agencies responsible for collecting and maintaining such information. AADT data may include link-based data, where links representing an intersection zone are of particular interest. It is to be understood that either sample count data 119 or AADT may be used for traffic volume data 118. Sample count data 119 from connected vehicles 112 may act as a proxy for volume that removes the need for AADT as an external data source.

Several other types and sources of input data 110 are possible, and are within the scope of the present invention. For example, input data 110 may include sensor data 120 collected from sensors that are positioned in a roadway itself, or within or proximate to a signalized intersection 104, in a transportation network 102. Sensors may include camera systems 121 (for example, imaging devices such as RGB, video, or thermal cameras) and ranging or radar systems 122. Other sensors from which sensor data 120 may be collected include magnetometers, acoustic sensors, loops, ultrasonic sensors, piezoelectric sensors, air pressure tubes, and any other sensors, devices or systems which may be used to determine information such as object location and vehicular speed.

Input data 110 may also include crowd-sourced observations 123. Such crowd-sourced observations 123 may be collected from individuals using mobile telephony devices or tablet computers that utilize software tools such as mobile applications, from social media feeds, or any other source or device permitting user entry of relevant information. Crowd-sourced observations 123 may be used to discern information such as events, road closures, pedestrian activities, and other relevant information.

Input data 110 may further include weather data 124. Weather data 124 may be ingested into the modeling framework 100 in a number of different forms and from different sources. For example, weather data 124 may be provided as real-time and/or predicted weather-related information, such as that calculated using weather radar systems. Predictions of weather-related issues such as precipitation that affect motorist behavior may also be provided from models that statistically project the movement of the current weather state into the future. These models may take data from numerical weather prediction models, surface networks, and both in-situ and remotely-sensed observation platforms, and use that information to generate future predictions of weather states. For example, output data from numerical weather models and/or surface networks may be combined with data from weather radars and satellites to reconstruct current weather conditions on any particular link or segment of roadway in a transportation network 102. It is to be noted that there are numerous industry models available, and any such models may be used to provide weather data 124 in the present invention from which relevant information is extracted.

Input data 110 also comprises historical crash data 125 representing prior collisions and crashes that have been reported and stored. As noted above, historical crash data 125 is typically contained within official crash records that are collected, verified, and published by various responsible agencies. The type and format of historical crash data 125 may vary depending on the responsible agency.

Regardless of type or content, it is to be understood that the modeling framework 100 may ingest input data 110 from a plurality of sources, and in a plurality of formats. It is to be further understood that input data 110 may be publicly, privately, or internally provided or developed (i.e. proprietary).

The modeling framework 100 includes a machine learning engine 150 that processes the input data 110 as follows, to produce predictions 172 of adverse traffic events, and enable one or more outputs as output data 180. The machine learning engine 150 provides an implementation of artificial intelligence in multiple machine learning algorithms and models that analyze data points within the input data 110 to identify relationships and draw correlations to more accurately analyze motorist behavior as it pertains to adverse traffic incidents and events, and as noted above, provide a proactive approach to intersection safety without having to wait for crashes to occur and historical data to accumulate prior to analyzing and identifying dangerous locations in a transportation network 102.

In the machine learning engine 150, a machine learning model 153 is developed for one or more signalized intersections 104 using a universe of data that is split into a training dataset 151 and a test dataset 152. The training dataset 151 includes historical crash data 125 for training the machine learning model 153. The machine learning engine 150 identifies factors that represent collision characteristics 155, and assigns weights to these factors as weighted parameters 154. As discussed further below, an iterative approach is utilized to determine a most ideal machine learning model 153, and this model is tested by applying it to event data 111 in the test dataset 152.

Once a final evaluation of the machine learning model 153 has been arrived at using the iterative approach described herein, the machine learning engine 150 then develops a prediction model 170 that may be applied to particular signalized intersections 104, even where no historical crash data 125 exists for those locations. The prediction model 170 generates predictions of adverse traffic events 172, and from these predictions 172, generates output data 180 that may be used by transportation managers to assess intersection safety and implement one or more traffic safety measures.

The machine learning engine 150 identifies factors that represent characteristic of events, speed, and intersection-related data represented in the input data 110 (and other factors, such as weather) that correspond to historical crashes at the intersection level (and therefore are most indicative that a crash occurred), and then calculates a weight for each such factor represented in the input data 110. The result is the set of weighted parameters 154. For example, the machine learning engine 150 may identify hard acceleration (HA) and hard braking (HB) as characteristics that correspond to historical crashes (and therefore, driving behavior that is most indicative of crashes). Values representing these weighted parameters 154 may also be summed to identify hard acceleration and hard braking events that occurred in a particular intersection zone, and this value may be assigned to each signalized intersection 104. These weighted parameters 154 are then assigned greater weights (and where summed, the sum may be assigned a greater weight) for the machine learning model 153 as discussed further herein.

Different methodologies may be applied to explore the effect of various factors in the input data 110 to determine collision characteristics 155 for the weighted parameters 154. An exploratory analysis of such factors may utilize, for example, a gini coefficient (a measurement of inequality among the values of a frequency distribution) to determine the variable importance. Other techniques 164 may also be applied to assess a relevancy of motorist behavior on collision characteristics 155 for identifying parameters 154.

Use of techniques such as a gini coefficient in an exploratory analysis of such factors indicates that hard acceleration (HA) is a highly dominant factor in estimating the number of crashes. In addition, speeding proportions over the speed limit are statistically more significant than an excessive speeding variable (e.g., 10 mph over the speed limit). Moreover, there is a strong correlation between the number of crashes and acceleration spikes at signalized intersections.

One or more machine learning algorithms are implemented in the modeling framework 100 to analyze the weighted parameters 154 and predict the occurrence of crashes at particular signalized intersections 104. It is to be understood that there are many types of machine learning techniques 164 that may be applied to such a problem, and therefore multiple implementations of machine learning algorithms and techniques are possible. For example, in the modeling framework 100 of the present invention, a root mean square error 162 analysis may be applied to each outcome of a testing version of the machine learning model 153 applying such machine learning techniques 164 (as noted below, regarding the comparative methodology) to determine which produces the most accurate validated results as described further below. The testing outcome of the machine learning model 153 with the lowest root mean square error 162 may therefore be selected for a prediction model 170, and applied on a go-forward basis to estimate the number of crashes that will occur over specified periods of time. Other approaches, also as noted below) may also be used to assess outcomes of the machine learning techniques 164 that may be applied to determine which produces the most accurate validated results.

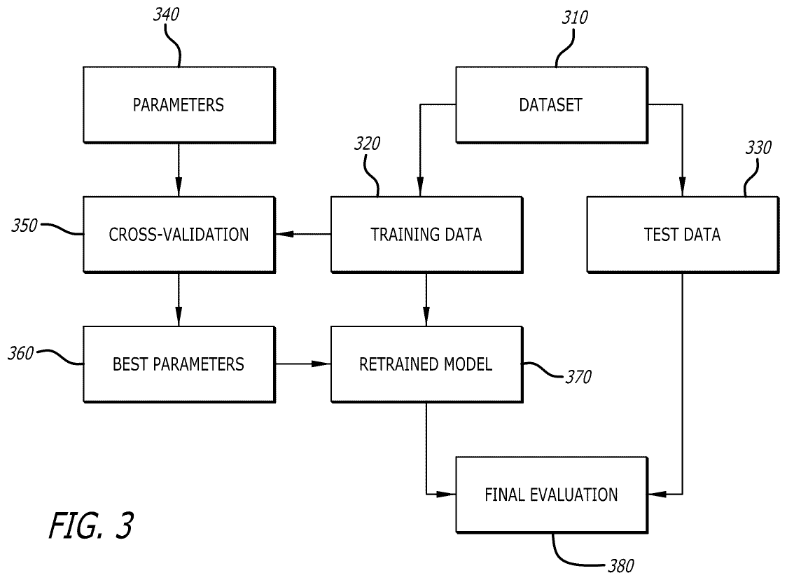

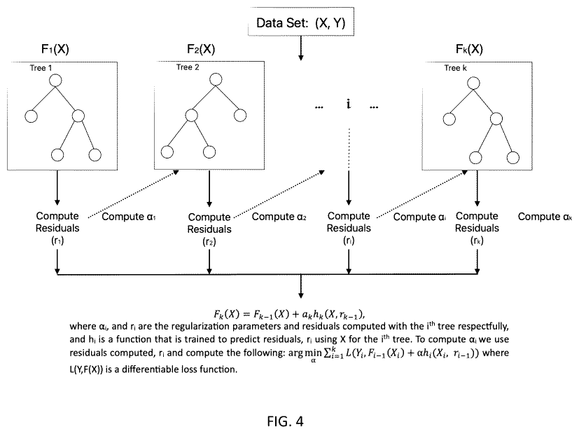

In one embodiment of the present invention, the machine learning engine 150 of the modeling framework 100 may apply algorithms that perform extreme gradient boosting (XGB) 160 to the input data 110. FIG. 4 is an illustration of how extreme gradient boosting may be applied and utilized to iteratively arrive at a set of best parameters as indicated as well in FIG. 3.

A machine learning model 153 developed by applying extreme gradient boosting 160 to the input data 110 may later be deployed in production to produce an output representing a risk of crashes. The machine learning engine 150 may therefore comprise one or more mathematical functions or equations that together comprise extreme gradient boosting 160. Extreme gradient boosting 160 attempts to minimize a loss function experienced by a model 153 by performing numerical optimization through adding weaker “learning” parameters using gradient descent. The application of extreme gradient boosting 160 as in FIG. 4 performs an iterative computation of residuals according to the function expressed therein, and exhibits the lowest mean square error 162 according to the comparative methodology described below.

Extreme gradient boosting 160 (which may also be referred to herein as XGB) is a machine learning-based model commonly used for classification and regression. XGB 160 creates a pre-defined number of weak learners (e.g., decision trees) and works as an ensemble method. However, XGB 160 works as a gradient-boosting model and creates those trees sequentially. While training, each tree corrects the errors made by the previous one:

$$\hat{f} = {\sum }_{n} {β}_{n} g ( x , {γ}_{n} )$$

where x is a vector of input variables, \hat{f} is the estimate for the response variable, g (x, γₙ) are single decision trees while the parameter γₙ points the split variables. Finally, βₙ is the coefficient to determine how each single tree is to be combined.

Extreme gradient boosting 160 is generally an application of iterative learning where a model predicts something initially and self-analyzes errors to give more weight to the connections where the model performed with higher accuracy, by extracting more relevant features associated with those connections from the input data 110. After the second iteration, it again self-analyzes its wrong predictions and gives more weight to the data points which are predicted as wrong in the next iteration. This process continues as a cycle. Therefore, if a prediction has been made, it is from a thorough understanding of patterns in the input data 110.

More generally, gradient descent is a first-order iterative optimization algorithm for finding a local minimum of a differentiable function. In gradient boosting, weak learner parameters train on remaining residual errors of a strong learner. By training on the residuals of the model, it gives more importance to mis-classified observations. Intuitively, new weak learners are added to concentrate on the areas where the existing learners are performing poorly. The contribution of each weak learner to the final prediction is based on a gradient optimization process to minimize the overall error of the strong learner.

The modeling framework 100 of the present invention develops and applies machine learning models 153 using extreme gradient boosting 160 to generate output data 180 based on predictions of adverse traffic events 172. These predictive outputs represent one or more attributes of a risk of crashes at a signalized intersection 104, and may therefore be used to develop a risk score 190 for each signalized intersection 104 being analyzed. The predictions of adverse traffic events 172 may also include information that indicates candidate locations for a range of traffic safety measures that may be taken to prevent a likelihood of crashes.

Traffic safety measures may include speed limit reduction 191, which may be implemented using, for example, an electronic sign at or near the signalized intersection 104 advising of a reduced speed limit. The output data 180 may therefore also include instructions 196 for actuating a physical system such as an electronic speed limit sign. Another traffic safety measure may include speed calming 192 (i.e., addition of speed bumps) to reduce traffic speed; these speed calming devices may be either permanently or temporarily installed.

Traffic intersection signals may also be adjusted to perform traffic safety measures. The output data 180 may therefore include signal timing adjustments 193 for traffic signal controllers, and instructions 196 may be generated for traffic signal controllers automatically to perform such signal timing adjustments 193.

Another possible traffic safety measure provided through output data 180 may include enhanced lighting 194. The output data 180 may be configured to automatically adjust existing lighting, by either strengthening an illumination of lighting that is already activated, or turn on additional nearby lighting. The output data 180 may therefore also include instructions 196 for automatically actuating lighting systems to perform such enhanced lighting 194.

Speed enforcement 195 is a further traffic safety measure that may be implemented from output data 180. Speed enforcement may occur, for example, via a police presence or through activation of camera systems that are able to capture vehicular speed and identification information. Instructions 196 may also be generated to actuate physical systems such as camera systems for speed enforcement 195.

Still further traffic safety measures may include acoustic or aural systems, such speakers, which may be actuated to provide an warning to vehicles, pedestrians, and other roadway users of an increased risk of collisions. Messages may be generated and displayed on signage at or near the signalized intersection 102, warning motorists, pedestrians, and other roadway users with a textual indicator that there is an increase safety risk. Signals may also be generated and transmitted to connected vehicles to provide some warning indicator—for example, a sound, a voice, or a flashing light on a screen inside a vehicle, warning of an increased risk of collision as the vehicle approaches a signalized intersection 104. As above, one or more instructions for actuating physical systems may be generated for acoustic/aural, textual, and connected vehicle warning indicators. It is to be understood that many examples of traffic safety measures are possible and within the scope of the present invention. Regardless, the predictive modeling of the present invention, and corresponding output data 180 and applications thereof, enable traffic planners to quickly identify and prioritize intersection safety through decisions that can be made in real time or near real time. This is particularly beneficial where historical crash datasets are unavailable, out of date, or otherwise of limited utility.

### Comparative Methodology

It is to be understood that the modeling framework 100 may utilize any type of machine learning technique 164, as well as multiple machine learning techniques 164 at the same time, in the course of analyzing the various types of input data 110 described herein. Accordingly, the present invention is not to be limited to any one specific type of machine learning described herein.

Nonetheless, the use of extreme gradient boosting 160 according to one embodiment of the present invention is the result of a comparative methodology for determining an appropriate machine learning technique 164 for the problems that the modeling framework 100 seeks to solve. Similarly, a minimum root mean square error 162-used in the modeling framework 100 as part of selecting the most appropriate technique 164—is but one performance metric for assessing accuracy of the machine learning model 153 given the various types of input data 110.

In this comparative methodology, a correlation matrix investigates correlation and interdependency of all variables that are relevant to traffic crashes or collisions. This correlation matrix is comprised, as noted above, of weighted parameters 154 representing collision characteristics in events, speed, and intersection-related information in the input data 110 that correspond to historical crashes. The dataset is split into a training dataset 151 and a test dataset 152, as noted above. A variety of conventional models may be tested, including forest-based regression and negative binomial regression. For testing of machine learning models, both random forest and extreme gradient boosting (XGB) are applied. Both of these machine learning techniques 164 outperform negative binomial regression as a benchmark for the outputs of the machine learning models 153, as explained further below.

The comparative methodology includes developing a machine learning model 153 that performs both training and testing modeling. The machine learning model 153 is initially trained, as noted above, on historical crash data 125. The test version of the machine learning model 153 ingests event data 111 and other information such as speed data 113 and intersection data 116, and the multiple machine learning techniques 164 discussed herein are applied to this input data 110. The results are validated using corresponding historical crash data 125 for the same location, where a location may represent a particular signalized intersection 104. The weighted parameters 154 that produce the most accurate validations against historical crash data 125 are then identified (for example, hard acceleration and hard braking), according to which machine learning technique 164 provides the lowest root mean square error 162.

During testing in this comparative methodology, machine learning-based models (applying either a random forest technique or an extreme gradient boosting technique) are able to estimate the number of crashes at a signalized intersection 104 within a root mean square error 162 of approximately ±22 crashes. Conversely, the root mean square error 162 where negative binomial regression applies was ±37 crashes. Within both machine learning-based models, extreme gradient boosting 160 outperformed random forest using root mean square error 162 (by ±21.91 crashes to ±22.12 crashes). Accordingly, the comparative methodology identified extreme gradient boosting 160 as the most accurate machine learning technique for estimating the occurrence of crashes at a signalized intersection 104. It is to be understood however, that random forest may also be applied as alternative machine learning technique 164, as the margin of error is within an acceptable limit.

It is to be further understood that the comparative methodology may continue to be applied for developing appropriate machine learning models 153 going forward, as additional input data 110 becomes available, and that different machine learning techniques 164 may be used where they provide the most accuracy for estimating the occurrence of crashes. Additionally, different techniques 164 may produce different results at different particular signalized intersections 104, for example where roadway geometry 117 may result in different outcomes. It is therefore to be still further understood that different machine learning techniques 164 may be utilized to arrive at the most accurate estimations of the occurrence of crashes, and that therefore the modeling framework 100 is not to be limited to any one specific type of approach used in machine learning models 153 that produces prediction models 170.

Performance metrics using actual examples for this methodology for selecting the most appropriate model may be explained as follows. After training the models with a training dataset 151 (for example, representing 2,853 intersections), the prediction performances of each model on the test dataset 152 (representing a smaller number, or 1,000 intersections) are compared using the following metrics. Spearman's rank correlation coefficient (rₛ) is a performance metric that focuses on the ranking of the intersections rather than estimating the actual number of crashes that occurred in each intersection:

$${r}_{s} = 1 - \frac{6 \sum ( R ( {P}_{i} ) - R ( {A}_{i} ) )}{n ( {n}^{2} - 1 )}$$

where R(Pᵢ)-R(Aᵢ) represents the ranking difference between the actual and predicted number of crashes for the intersection i while n indicates the number of observations. Root mean square error (RMSE) 162 is another prediction performance measurement that represents the absolute average error of the predictions made by each model:

$$RMSE = \sqrt{\sum {( {P}_{i} - {A}_{i} )}^{2}}$$

where Pᵢ and Aᵢ indicates the predicted and actual number of crashes for intersection i, respectively.

To evaluate the feasibility of event data 111 and speeding proportions on network screening and intersection safety ranking, in the comparative methodology the three models above are trained using the 2,853-intersection training dataset 151, and their performances are compared on the 1,000-intersection test dataset 152. All three models rank the intersections 104 with a statistically significant correlation on a higher than 99% confidence level. Therefore, one month of acceleration change events and aggregated speeding behaviors are able to help identify crash-prone intersections even though the historical crash data 125 is lagging two or more years behind. Among the three models, XGB presents the highest-ranking correlation coefficient and lowest RMSE. Also, ML-based models generally perform with a lower range of error compared to the negative binomial regression model, which returned significantly overestimated results for three intersections exceeding 300 crashes. Therefore, random forest and XGB predictions are much more condensed around the actual number of crashes compared to negative binomial regression model.

The comparative methodology there enables the modeling framework 100 to generate and deploy prediction models 170 for production that analyze relevant input data 110 going forward and generate predictions of adverse traffic events 172 that represent the highest likelihood of accuracy. These prediction models 170 further enable outputs as metrics that include estimates of crash occurrences and intersection risk scoring. This comparative methodology enables the modeling framework 100 to be particularly beneficial, as noted above, where historical crash datasets are unavailable, out of date, or otherwise of limited utility, for real-time or near real-time decision-making despite the lack of available historical information.

It is also therefore to be understood that there are many types of techniques 164 of machine learning that may be applied to such a problem, and therefore multiple techniques 164 are possible. Such techniques 164 may include applications of neural networks and other machine learning approaches, and therefore the present specification is not to be limited to any specific type of machine learning approach referenced herein; one of skill in the art will appreciate that different types of such approaches may be applied to arrive at the outputs and outcomes described herein.

In the modeling framework 100 of the present invention, a root mean square error 162 analysis may be applied to outcomes of each model to determine which such techniques 164 produced the most accurate validated results. The model with the lowest root mean square error 162 may therefore be selected for a production model, and applied on a go-forward basis to estimate the number of crashes that will occur over specified periods of time. Nonetheless, it is to be further understood that other techniques 164 for evaluating accuracy of a machine learning-based model may also be utilized, and are within the scope of the present invention. The present specification is therefore not to be limited to any type of machine learning model, or any method for evaluating accuracy of any such model, that is expressed herein.

### Neural Networks

Many other types of machine learning techniques 164 are possible, and as noted above, within the scope of the present invention. These may include, but are not limited to, k-nearest neighbor (KNN), logistic regression, support vector machines or networks (SVM), and as further noted above, one or more neural networks.

Neural networks may be applied in the modeling framework 100 of the present invention to identify and model appropriate relationships between data points to provide a more accurate understanding of how various characteristics result in collisions, crashes, and other adverse traffic events. There are many types of neural networks, which are computing systems that “learn” to perform tasks in a supervised manner without being programmed with task-specific rules, based on examples. Neural networks are generally comprised of nodes, which are computational units having one or more biased input/output connections. Such biased connections act as transfer (or activation) functions that combine inputs and outputs in some way. Neural networks are based on arrays of connected, aggregated nodes (or, “neurons”) that transmit signals to each other in the multiple layers over the biased input/output connections. Connections, as noted above, are activation or transfer functions which “fire” these nodes and combine inputs according to mathematical equations or formulas. Different types of neural networks generally have different configurations of these layers of connected, aggregated nodes, but they can generally be described as an input layer, a middle or ‘hidden’ layer, and an output layer. These layers perform different transformations on their various inputs, using different mathematical calculations or functions. Signals travel between layers, from the input layer to the output layer via the middle layer, and may traverse layers, and nodes, multiple times.

Signals are transmitted between nodes over connections, and the output of each node is calculated in a non-linear function that sums all of the inputs to that node. Weight matrices and biases are typically applied to each node, and each connection, and these weights and biases are adjusted as the neural network processes inputs and transmits them across the nodes and connections. These weights represent increases or decreases in the strength of a signal at a particular connection. Additionally, nodes may have a threshold, such that a signal is sent only if the aggregated output at that node crosses that threshold. Weights generally represent how long an activation function takes, while biases represent when, in time, such a function starts; together, they help gradients minimize over time. At least in the case of weights, they can be initialized and change (i.e., decay) over time, as a system learns what weights should be, and how they should be adjusted. In other words, neural networks evolve as they learn, and the mathematical formulas and functions that comprise a neural network can change over time as a system improves itself.

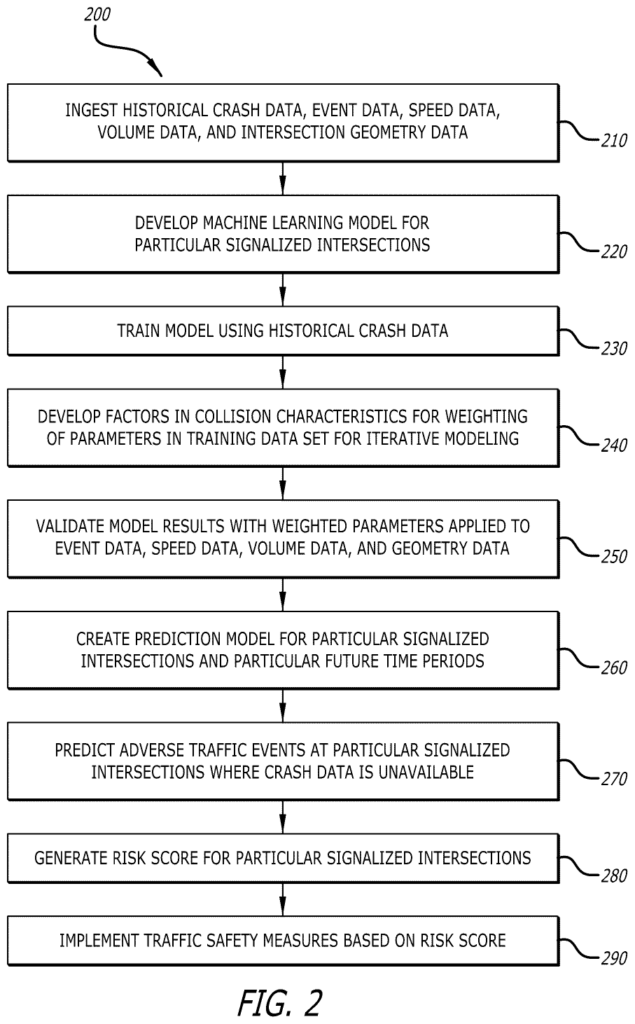

### FIG. 2

FIG. 2 is a flow diagram illustrating a process 200 for predicting adverse traffic events, and generating follow-on outputs, at a signalized intersection 104 within a transportation network 102, according to one embodiment of the present invention. In this process 200, at step 210 input data 110 is ingested that comprises historical crash data 125, event data 111, speed data 113, and intersection data 116, into a modeling framework 100. At step 220, the modeling framework 100 invokes a machine learning engine 150 to develop a machine learning model 153 for particular signalized intersections 104.

The machine learning model 153 is then trained on historical crash data 125 using a training dataset 151 at step 230, across a plurality of signalized intersections 104. Next, the process 200 includes developing, at step 240, a plurality of factors representing collision characteristics 155 in the training dataset 151 that are weighted for the purpose of iterative modeling using machine learning techniques 164 such as extreme gradient boosting 160 to arrive at the most appropriate weighted parameters 154. At step 250, these weighted parameters 154 are applied to other input data 110, such as event data 111, speed data 113, and intersection geometry data 116, in the machine learning model 153 to validate the outcomes thereof. The process 200 then produces a prediction model 170 at step 260, for particular signalized intersections 104. The prediction model 170 generates predictions of adverse traffic events 172 at future time periods for the particular signalized intersections 104 at step 270, where historical crash data 125 is unavailable.

At step 280, these predictions 172 are used to generate a risk score 190 for the particular signalized intersections 104. At step 290, the process 200 includes implementing one or more traffic safety measures in response to one or both of the predictions of adverse traffic events 172, and the risk score 190, for the particular signalized intersections 104.

### FIG. 3

FIG. 3 is a block diagram illustrating how a dataset 310 is applied to a machine learning model 153, according to one embodiment of the present invention. A dataset 310 is split into training data 320 and test data 330. Parameters 340 are identified and weighted from the training data 320, and used for cross-validation 350 of the machine learning model 153. A set of best parameters 360 are iteratively selected using machine learning algorithms that perform extreme gradient boosting 160 (or, where applicable, other machine learning techniques 164), and these best parameters 360 are applied to a retrained model 370. The test data 330 is then applied to the retrained model 370 for further validation to produce a final evaluation 380 of the machine learning model 153. The final evaluation 380 yields a production version of a prediction model 170 that may be deployed by the modeling framework 100.

An example of how a dataset 310 may be split for training data 320 and test data 330 may be as follows. If for, example, data exists for 3000 signalized intersections 104, and for each there exists data that represents speeding, volume, geometry, crashes and connected vehicle-related events, the modeling framework 100 may randomly select 30% of those intersections and separate the dataset 310 for model testing and validation, so that 70% of the intersections are used for model training. After calibrating the machine learning model 153 using training data 320, the machine learning model 153 is applied to the test data 330, meaning that weights and parameter shares calculated by machine learning engine 150 are applied to see how accurately they estimate number of crashes for the test data 330. The error may then be measured, since the number of crashes for the test data 330 is known. Therefore, error is the difference between estimation and historical crash counts.

The systems and methods of the present invention may be implemented in many different computing environments 130. For example, they may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, GPU and any comparable means. Still further, the present invention may be implemented in cloud-based data processing environments, and where one or more types of servers are used to process large amounts of data, and using processing components such as CPUs, GPUs, TPUs, and other similar hardware. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors or general processing units), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be wholly or partially implemented in software that can be stored on a non-transitory computer-readable storage medium, executed on programmed general-purpose computer with the cooperation of a controller and memory, a special purpose computer, a microprocessor, or the like. In these instances, the systems and methods of this invention can be implemented as a program embedded on a mobile device or personal computer through such mediums as an applet, JAVA® or CGI script, as a resource residing on one or more servers or computer workstations, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, machine learning, artificial intelligence, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. For example, the input data 110 may also include information such as crowd-sourced observations from motorists and others present at a signalized intersection 104, meteorological information representing weather conditions present at a signalized intersection 104, and sensor data 120 collected from sensors such as radar systems and cameras present at or near a signalized intersection. Still further, the machine learning-based models may include applications of neural networks that identify and assign weights and biases to various nodes, representing parameters that are relevant to a problem to be solved. Additionally, a traffic intersection 104 need not be signalized; instead, it may be a two-way or four-way stop intersection. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method, comprising:
receiving, as input data, available historical crash data at a plurality of signalized intersections, and data representing motorist behavior relative to the plurality of signalized intersections that includes one or more of event data, speed data, traffic volume data, and intersection geometry data;
analyzing the input data in a machine learning-based engine, by
building a machine learning model that is calibrated using the available historical crash data in a training dataset,
validating the machine learning model using a test dataset that at least includes the one or more of the event data, speed data, traffic volume data, and intersection geometry data,
assigning weights to a plurality of parameters indicative of a risk of collisions identified in the training dataset, wherein the weights are relative at least to speeding, intersection geometry, traffic volume, hard braking behavior, and hard acceleration behavior,
applying the weights to the test dataset for the machine learning model,
developing a prediction model from the machine learning model to generate predictions of adverse traffic events for particular signalized intersections for which historical crash data is not available at one or more future time periods from the one or more of the event data, speed data, traffic volume data, and intersection geometry data; and
generating a risk score for the particular signalized intersections from the predictions of the adverse traffic events.

2. The method of claim 1, further comprising actuating a system for implementing traffic safety measures based on the risk score for the particular signalized intersections.

3. The method of claim 2, wherein the system for implementing traffic safety measures includes at least one of a signal timing adjustment, a lighting change, an automated speed enforcement device, and an automated speed limit reduction device.

4. The method of claim 1, further comprising initiating a traffic safety measure based on the risk score for the particular signalized intersections, the traffic safety measure including one or more of speed limit reduction, speed calming, and speed enforcement.

5. The method of claim 1, wherein the event data is data collected from connected vehicles, and includes acceleration change events, ignition status events, and seatbelt status information, and wherein each of the acceleration change events, ignition status events, and seatbelt status information include a time stamp, a location, a speed, and heading information.

6. The method of claim 5, wherein the acceleration change events include hard acceleration information and hard braking information, the ignition status events include a trip started indication and a trip ended indication, and the seatbelt status information includes a seat belt clicked indicator, and a seat belt unclicked indicator.

7. The method of claim 1, wherein the traffic volume data is one or both of sample count data collected from connected vehicles and average daily traffic volume specific (AADT).

8. The method of claim 1, wherein the speed data is determined from data collected from one or more sensors positioned at or near the plurality of signalized intersections, or determined from one or more crowd-sourced probe datasets.

9. A method of scoring an intersection based on predicted adverse traffic events within a transportation network for risk, comprising:
calibrating a training and validation model using available historical crash data at a plurality of signalized intersections in a training dataset;
validating the training and validation model using a test dataset that at least includes data representing motorist behavior relative to the plurality of signalized intersections that includes one or more of event data, speed data, traffic volume data, and intersection geometry data;
identifying a plurality of parameters indicative of a risk of collisions in the training dataset;
weighting the plurality of parameters relative at least to speeding, intersection geometry, traffic volume, hard braking behavior, and hard acceleration behavior in one or more assigned weights;
applying the one or more assigned weights to the test dataset; and
predicting adverse traffic events for particular signalized intersections at one or more future time periods in a prediction model,
wherein a risk score for the particular signalized intersections is generated from predictions of the adverse traffic events, and
wherein the training and validation model and the prediction model comprise a machine learning-based engine for analyzing the one or more of the event data, speed data, traffic volume data, and intersection geometry data where historical crash data is not available.

10. The method of claim 9, further comprising actuating a system for implementing traffic safety measures based on the risk score for the particular signalized intersections.

11. The method of claim 10, wherein the system for implementing traffic safety measures includes at least one of a signal timing adjustment, a lighting change, an automated speed enforcement device, and an automated speed limit reduction device.

12. The method of claim 9, further comprising initiating a traffic safety measure based on the risk score for the particular signalized intersections, the traffic safety measure including one or more of speed limit reduction, speed calming, and speed enforcement.

13. The method of claim 9, wherein the event data is data collected from connected vehicles, and includes acceleration change events, ignition status events, and seatbelt status information, and wherein each of the acceleration change events, ignition status events, and seatbelt status information include a time stamp, a location, a speed, and heading information.

14. The method of claim 13, wherein the acceleration change events include hard acceleration information and hard braking information, the ignition status events include a trip started indication and a trip ended indication, and the seatbelt status information includes a seat belt clicked indicator, and a seat belt unclicked indicator.

15. The method of claim 9, wherein the traffic volume data is one or both of sample count data collected from connected vehicles and average daily traffic volume specific (AADT).

16. The method of claim 9, wherein the speed data is determined from data collected from one or more sensors positioned at or near the plurality of signalized intersections, or determined from one or more crowd-sourced probe datasets.

17. A system for scoring an intersection based on predicted adverse traffic events within a transportation network for risk, comprising:
a machine learning-based engine, configured to:
calibrate a training and validation model using available historical crash data at a plurality of signalized intersections in a training dataset;
validate the training and validation model using a test dataset that at least includes data representing motorist behavior relative to the plurality of signalized intersections that includes one or more of event data, speed data, traffic volume data, and intersection geometry data;
identify a plurality of parameters indicative of a risk of collisions in the training dataset;
assign weights to the plurality of parameters relative at least to speeding, intersection geometry, traffic volume, hard braking behavior, and hard acceleration behavior;
apply the one or more assigned weights to the test dataset; and
a prediction model configured to generate predictions of adverse traffic events for particular signalized intersections at one or more future time periods,
wherein a risk score for the particular signalized intersections is generated from the predictions of the adverse traffic events, and
wherein the machine learning-based engine analyzes the one or more of the event data, speed data, traffic volume data, and intersection geometry data where historical crash data is not available.

18. The system of claim 17, wherein a system for implementing traffic safety measures is actuated based on the risk score for the particular signalized intersections.

19. The system of claim 18, wherein the system for implementing traffic safety measures includes at least one of a signal timing adjustment, a lighting change, an automated speed enforcement device, and an automated speed limit reduction device.

20. The system of claim 17, wherein a traffic safety measure is initiated based on the risk score for the particular signalized intersections, the traffic safety measure including one or more of speed limit reduction, speed calming, and speed enforcement.

21. The system of claim 17, wherein the event data is data collected from connected vehicles, and includes acceleration change events, ignition status events, and seatbelt status information, and wherein each of the acceleration change events, ignition status events, and seatbelt status information include a time stamp, a location, a speed, and heading information.

22. The system of claim 21, wherein the acceleration change events include hard acceleration information and hard braking information, the ignition status events include a trip started indication and a trip ended indication, and the seatbelt status information includes a seat belt clicked indicator, and a seat belt unclicked indicator.

23. The system of claim 17, wherein the traffic volume data is one or both of sample count data collected from connected vehicles and average daily traffic volume specific (AADT).

24. The system of claim 17, wherein the speed data is determined from data collected from one or more sensors positioned at or near the plurality of signalized intersections, or determined from one or more crowd-sourced probe datasets.
